(19) United States
(12) Patent Application Publication
(10) Pub. No.: US 2015/0117803 A1
(43) Pub. Date: Apr. 30, 2015

(54) AIR PRESSURE BEARING

(71) Applicant: Schaeffler Technologies GmbH & Co. KG, Herzogenaurach (DE)

(72) Inventors: Yohannes Haile, Canton, MI (US); Zheng Wang, Rochester Hills, MI (US)

(73) Assignee: Schaeffler Technologies GmbH & Co. KG, Herzogenaurach (DE)

(21) Appl. No.: 14/557,657

(22) Filed: Jan. 5, 2015

(51) Int. Cl. F16C 32/06

(52) U.S. Cl. CPC F16C 32/0614
USPC 384/119

(57) ABSTRACT

An air pressure bearing including a bearing including an outer bearing race and inner bearing race with a bearing gap therebetween, mounted between an outer race support ring and inner race support structure. Pressurized air is monitored, for example air pressure and flow rate, and supplied to the bearing and exhausted from the bearing. A control module is used to adjust characteristics of the pressurized air to achieve design application parameters, such as load carrying, stiffness and dampening. A method of controlling an active air pressure bearing is also described, including providing and monitoring pressurized air and adjusting air supply to meet application design parameters.

### TECHNICAL FIELD

The present disclosure relates to an air pressure bearing, in particular a method of operating and structure of an active air pressure bearing.

### BACKGROUND

Fluid film bearings using air as the lubricating film are known, wherein, a thin film of pressurized air is used as a low friction load bearing medium between bearing surfaces. Such bearings are designed to maintain a certain support load and supply a designed air pressure. Although air constantly escapes from the bearing gap, the pressure between the faces of the bearing is enough to support the working loads. Hydrodynamic air bearings use the relative motion between components to establish the air lubricating film. Hydrostatic air bearings establish the air film through an external pressure source. Typically air bearings are passive, using an external pressure source with a constant pressure supply to provide the air lubricating film.

Air is fed into the bearing gap or running surface through orifice feeding, wherein an appropriately sized hole in the bearing is designed in connection with a pressurized air supply, or through a porous material, such as carbon or bronze, wherein the pressurized air penetrates through the material into the bearing gap.

### SUMMARY

According to aspects illustrated herein, there is provided an active air pressure bearing, including: a perforated outer race support ring with air supply and air exhaust ports passing through the ring; an outer bearing race mounted radially within the outer bearing race support ring; an inner bearing race axially aligned with the outer bearing race, to form a bearing gap therebetween, and pressed on an inner bearing race support structure; two seals mounted on axially opposite ends of the inner and outer bearing races, to form two axially opposed low air pressure gaps, and radially between the outer bearing race support ring and the inner bearing race support structure; an external air pressure generating device to provide supply air to the air supply port; at least one supply sensor configured to monitor supply air provided to the air supply port; at least one exhaust sensor configured to monitor exhaust air exiting the air exhaust port; and a control module configured to receive information from the supply sensor and exhaust sensor and modify operation of the external air pressure generating device according to pre-determined design parameters.

According to aspects illustrated herein, there is provided a method of operating an air pressure bearing, the method including the steps of: providing pressurized air to an air supply port; monitoring defined characteristics of the pressurized air; delivering the pressurized air to a bearing gap; exhausting the exhaust air from the bearing gap through an air exhaust port; monitoring defined characteristics of the exhaust air; supplying the characteristics of the pressurized air and the exhaust air to a control module; and modifying the characteristics of the pressurized air in response to the monitored characteristics of the pressurized air and exhaust air according to design parameters. The method can include continuously monitoring the supply and exhaust air characteristics and continuously modifying supply air characteristics.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a cross sectional view of an air pressure bearing according to one example embodiment;

FIG. 3 is a schematic drawing of the steps of operating an air pressure bearing according to one example embodiment.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

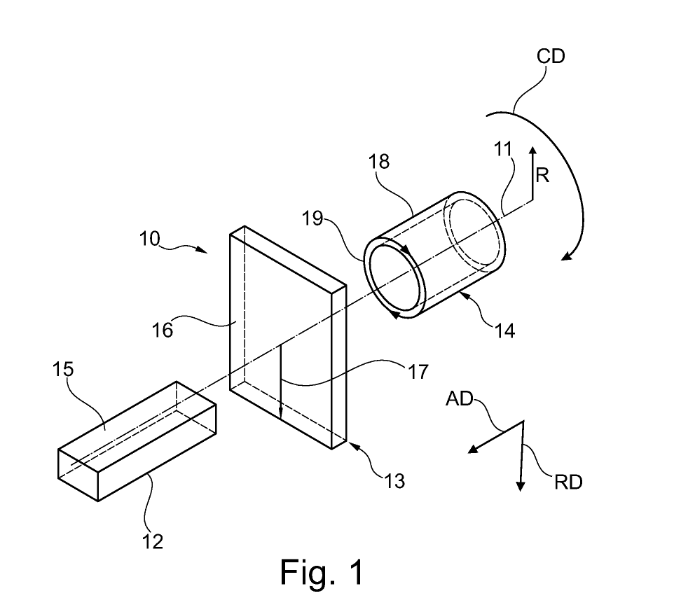

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

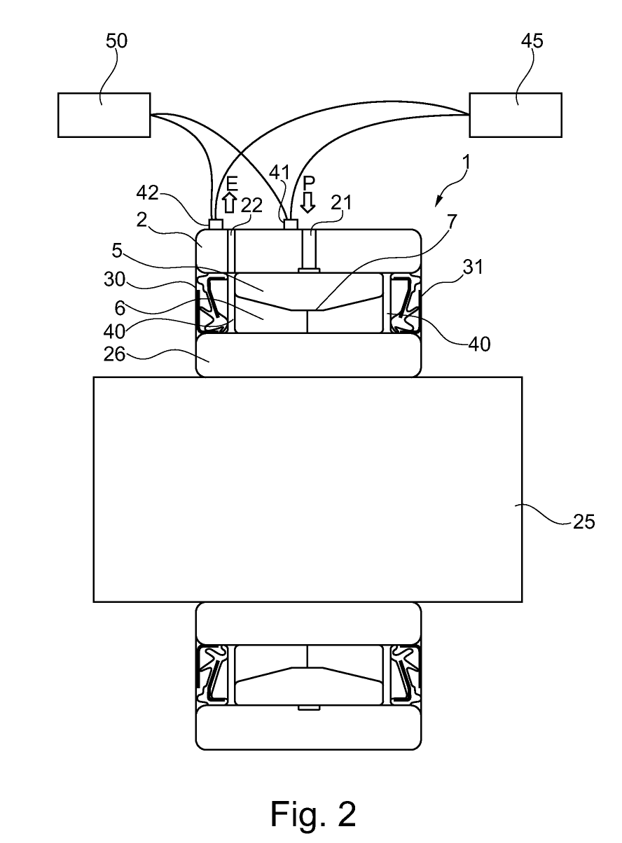

FIG. 2 is a cross sectional view of air pressure bearing 1 according to one example embodiment. Air pressure bearing 1 includes; perforated outer bearing race support ring 2 with pressurized air supply port 21 to supply pressurized air P and air exhaust port 22 to remove exhaust air E; outer bearing race 5 mounted radially within outer bearing race support ring 2; inner bearing race 6 axially aligned with outer bearing race 5, to form bearing gap 7 therebetween, and pressed onto an inner bearing race support structure 26; two seals 30 mounted on axially opposite ends of the inner bearing race 6 and outer bearing race 5, to form two axially opposed low air pressure gaps 40, and radially between outer bearing race support ring 2 and inner bearing race support structure 26; an external air pressure generating device 50 to provide pressurized or supply air P to air supply port 21; at least one supply sensor 41 configured to monitor pressurized or supply air P provided to air supply port 21; at least one exhaust sensor 42 configured to monitor exhaust air E exiting air exhaust port 22; and control module 45 configured to receive information from supply sensor 41 and exhaust sensor 42 and modify operation of the external air pressure generating device (not shown) according to pre-determined design parameters.

Outer bearing race 5 is shown as a porous material, for example, sintered powder metal or bronze, in this example embodiment, however it will be understood by one skilled in the art that outer bearing race 5 can have an air supply orifice to supply pressurized air to bearing gap 7. In addition, although supply sensor 41 and exhaust sensor 42 are shown as mounted on outer bearing race support ring 2 for convenience, it will be understood by one skilled in the art that sensors 41 and 42 may be located remotely from air pressure bearing 1 Inner bearing race support structure 26 is shown as an inner bearing race support ring, mounted onto an associated device (not shown) machine shaft 25, however, inner bearing race support structure 26 may be the machine shaft 25 itself or a combination of inner bearing race support ring and machine shaft 25.

Low pressure gap or zone 40 is to enable use of relatively low cost seals 31 in the system. It will be understood by one skilled in the art that gap 40 may also be pressurized and higher performance pressure seals used. Sensors 41 and 42 monitor and measure defined characteristics of pressurized or supply air P and exhaust air E, for example air pressure and flow rate. This measured data and information is supplied to control module 45, and, in turn, used by control module 45 to modify the pressurized or supply air P characteristics coming from the external air pressure generating device 50. In this way air pressure bearing 1 is capable of providing controllable stiffness and dampening characteristics to meet desired applications requirements.

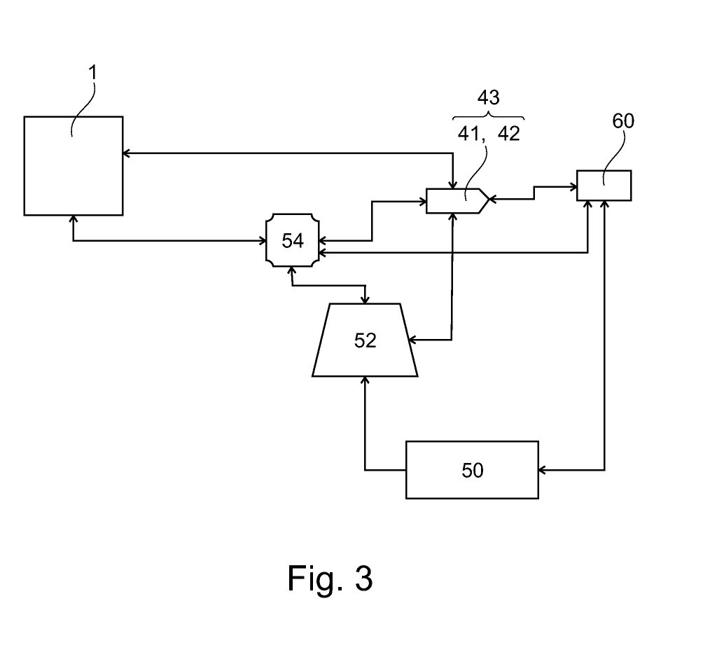

FIG. 3 is a schematic drawing of an exemplary method of operating an air pressure bearing. A control module 60 controls operation of external air pressure generating device 50, sending pressurized air, in this example embodiment, to pneumatic storage unit 52 and through pneumatic control module 54 to air pressure bearing 1. Although pneumatic storage 52 is not required it can equalize and provide consistent air pressure supply. As air enters bearing 1, supply sensor 41 measures defined characteristics of supply or pressurized air P, such as air pressure and flow rate, and sends that information to control module 60. As exhaust air E exhausts from bearing 1, exhaust sensor 42 measured defined characteristics of exhaust air E, such as air pressure and flow rate, and sends that information to control module 60. Sensors 41, 42 can be combined into a single sensor suite 43. Control module 60 is programmed with defined application parameters, for example stiffness, load support and dampening of bearing 1, modifying supply or pressurized air by modifying operation of generating device 50 in order to achieve those programmed application parameters. Control module 60 can also operate pneumatic control module 54 to continuously supply desired supply air P characteristics.

In this example embodiment, air bearing 1 has at least three states to optimize operational efficiency, as described in Table 1. In Table 1, air bearing 1 is alternatively described a active air bearing, active air non-contact bearing, or A2NCB.

TABLE 1

| State | | System/vehicle | | A2NCB State |
|---|---|---|---|---|
| ID | State Name | Condition | A2NCB State | Description |
| S0 | Off state | Power off | Power off | Air storage hold |
| | | | | mode |
| S1 | Idle/Charge | Power on, no load/not | Power on, sensor suite on, | Target P achieved, |
| | state | moving | static air gap, stiffness, | pneumatic storage |
| | | | dampening set | being charged |
| S2 | Dynamic | Load induced/vehicle | Power on, sensor suite on, | A2NCB fully |
| | state | moving | dynamic min. air gap | actuated, pressure, |
| | | | achieved, dynamic stiffness, | air gap, stiffness, |
| | | | dampening control | dampening |
| | | | | actively |
| | | | | controlled, |
| | | | | pneumatic storage |
| | | | | fully active |

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A device comprising:
a perforated outer race support ring, including:
an air supply port passing through the ring; and
an air exhaust port passing through the ring;
an outer bearing race mounted radially within the outer bearing race support ring;
an inner bearing race axially aligned with the outer bearing race, to form a bearing gap therebetween, and pressed on an inner bearing race support structure;
two seals mounted on axially opposite ends of the inner and outer bearing races, to form two axially opposed low air pressure gaps, and radially between the outer bearing race support ring and the inner bearing race support structure;
an external air pressure generating device to provide supply air to the air supply port;
at least one supply sensor configured to monitor supply air provided to the air supply port;
at least one exhaust sensor configured to monitor exhaust air exiting the air exhaust port; and
a control module configured to receive information from the supply sensor and exhaust sensor and modify operation of the external air pressure generating device according to pre-determined design parameters.

2. The device of claim 1, wherein the outer bearing race is a porous material that allows pressurized air to penetrate the outer bearing race into the bearing gap.

3. The device of claim 2, wherein the outer bearing race is made from sintered or powdered metal.

4. The device of claim 1, wherein the outer bearing race includes an orifice arranged to receive air through the air supply port and guide air to the bearing gap.

5. The device of claim 1, wherein the inner bearing race support structure is an inner race support ring mounted on a machine shaft.

6. The device of claim 1, wherein the inner bearing race support structure is a machine shaft.

7. A method of operating an air pressure bearing, the method comprising the steps of:
providing pressurized air to an air supply port;
monitoring defined characteristics of the pressurized air;
delivering the pressurized air to a bearing gap;
exhausting the exhaust air from the bearing gap through an air exhaust port;
monitoring defined characteristics of the exhaust air;
supplying the characteristics of the pressurized air and the exhaust air to a control module; and
modifying the characteristics of the pressurized air in response to the monitored characteristics of the pressurized air and exhaust air according to design parameters.

8. The method of claim 7, wherein the defined characteristics of the pressurized air includes air pressure and flow rate.

9. The method of claim 7, wherein the defined characteristics of the exhaust air includes air pressure and flow rate.

10. The method of claim 7, wherein the step of modifying the characteristics of the pressurized air includes the step of continuously changing air pressure of the pressurized air.

11. The method of claim 7, wherein the step of monitoring defined characteristics of the pressurized air includes the step of utilizing a sensor package to monitor defined characteristics of the pressurized air.

12. The method of claim 7, wherein the step of providing pressurized air to an air supply port includes the steps of:
generating pressurized air;
charging a pneumatic storage; and
controlling a pneumatic control module.
